(19) United States
(12) Patent Application Publication
(10) Pub. No.: US 2026/0131442 A1
(43) Pub. Date: May 14, 2026

(54) POWER TOOL HAVING A HAMMER MECHANISM

(71) Applicant: Makita Corporation, Anjo-shi (JP)

(72) Inventors: Tomohiro SAEKI, Anjo-shi (JP); Masanori FURUSAWA, Anjo-shi (JP); Yuji SAKAKIBARA, Anjo-shi (JP)

(73) Assignee: Makita Corporation, Anjo-shi (JP)

(21) Appl. No.: 19/379,213

(22) Filed: Nov. 4, 2025

(30) Foreign Application Priority Data
Nov. 11, 2024 (JP) 2024-196581

(51) Int. Cl. B25D 17/04; B25D 11/06; B25D 16/00

(52) U.S. Cl. CPC B25D 17/04; B25D 11/06; B25D 16/00; B25D 2250/095; B25D 2250/121

(57) ABSTRACT

A power tool having a hammer mechanism has a tool holder, a motor, a driving mechanism, a tool body, a handle and an operation member. The handle is connected to the tool body and includes a grip part extending in a first direction crossing a driving axis. The operation member is provided on a front side of the grip part and configured to be manually operated by a user to instruct start of the motor. The grip part has a first end that is closer to the tool body and a second end that is farther from the tool body in the first direction crossing the driving axis. The operation member is arranged in a region of the grip part that includes at least a center position of the grip part that is substantially equidistant from the first and second ends in the first direction.

### CROSS-REFERENCE TO RELATED APPLICATION

The present application claims priority to Japanese patent application No. 2024-196581 filed on November 11, 2024. The contents of the foregoing applications are hereby fully incorporated herein by reference.

### TECHNICAL FIELD

The present disclosure relates to a power tool having a hammer mechanism.

### BACKGROUND

A power tool having a hammer mechanism is configured to perform a machining operation on a workpiece by striking and linearly driving a tool accessory along a driving axis. Various kinds of tool accessories suitable for various machining operations can be selectively mounted to the power tool. The power tool of a relatively small portable type easy to use for various machining operations includes those of a so-called pistol grip type and a loop type in which a handle forms a loop together with part of a tool body (see Japanese Unexamined Patent Application Publication Nos. 2019-38093 and 2022-036600, respectively)

### SUMMARY

Both of the above-described power tools having a hammer mechanism are designed to have a handle shaped such that a user can easily hold a grip part and easily press a tool accessory onto a workpiece along the driving axis. Further, an operation member for starting the motor is arranged on the grip part so as to be easily operated in an attitude in which the grip part is placed below the driving axis in the vertical direction. This power tool however leaves room for further improvement in the operability when used in other attitudes.

It is accordingly a non-limiting object of the present disclosure to provide a power tool having a hammer mechanism that exhibits superior operability in various attitudes.

According to one non-limiting aspect of the present disclosure, a power tool having a hammer mechanism is provided that has a tool holder, a motor, a driving mechanism, a tool body, a handle and an operation member.

The tool holder extends along a driving axis that defines a front-rear direction of the power tool. A front end part of the tool holder is configured to removably hold a tool accessory selected from various kinds of tool accessories. The motor includes an output shaft that is rotatable around a first rotational axis. The driving mechanism is operably connected to the output shaft. The driving mechanism is configured to linearly drive a tool accessory held by the tool holder, along the driving axis when the motor is driven. The tool body extends along the driving axis and houses the tool holder, the motor and the driving mechanism. The handle is connected to the tool body and includes a grip part. The grip part extends in a first direction crossing the driving axis. The operation member is provided on a front side of the grip part and configured to be manually operated by a user to instruct start of the motor. The grip part has a first end that is closer to the tool body and a second end that is farther from the tool body, in the first direction. The operation member is arranged in a region of the grip part that includes at least a center position of the grip part that is substantially equidistant from the first and second ends in the first direction.

The handle of the power tool having a hammer mechanism according to this aspect has the grip part that extends in the first direction crossing the driving axis. The operation member is configured to be manually operated by a user to instruct start of the motor and arranged in a region including a center position of the grip part in the first direction (in the longitudinal direction of the grip part). Thus, the operation member can be easily operated with one or more fingers of a user, whether the user holds the grip part in an orientation with a thumb on a first end side (the tool body side) of the grip part (hereinafter referred to as a normal orientation), or in an orientation with the thumb on a second end side (opposite side from the tool body) of the grip part (hereinafter referred to as a reverse orientation). Further, the power tool can be used in various attitudes, but the orientation in which the grip part is held does not substantially affect the operability of the operation member, so that the power tool exhibits superior operability in various attitudes.

### BRIEF DESCRIPTION OF THE DRAWINGS

FIG. 1 is a left side view of a power tool having a hammer mechanism (according to a first embodiment), with a battery mounted thereto.

FIG. 2 is a rear perspective view of the power tool having a hammer mechanism, with the battery removed therefrom.

FIG. 3 is a perspective view of a needle scaler.

FIG. 4 is a partly sectional view of the needle scaler.

FIG. 5 is a sectional view of the power tool having a hammer mechanism, with a tool accessory being pressed onto a workpiece.

FIG. 6 is a sectional view taken along line VI-VI in FIG. 5.

FIG. 7 is a partial, enlarged view of FIG. 5.

FIG. 8 is a sectional view taken along line VIII-VIII in FIG. 5, and an explanatory view for showing a loaded state.

FIG. 9 is a sectional view corresponding to FIG. 7, and showing the power tool with the needle scaler mounted thereto, in a no-load state.

FIG. 10 is a sectional view corresponding to FIG. 7, and showing the power tool with a tool accessory other than the needle scaler mounted thereto, in a no-load state.

FIG. 11 is an explanatory view for showing a using manner of the power tool with a scoop mounted thereto.

FIG. 12 is a sectional view of a power tool having a hammer mechanism according to a second embodiment.

### DETAILED DESCRIPTION OF THE EMBODIMENTS

In one non-limiting embodiment according to the present disclosure, the operation member may be arranged apart from the first and second ends of the grip part in the first direction. According to this embodiment, the operation member is provided that can be easily operated by a user holding the grip part. Further, the operation member may be supported by the grip part so as to be linearly slidable. In this case, the operation member that can be easily moved by manual operation is provided with a simple structure.

In addition or in the alternative to the preceding embodiments, the operation member may extend from the first or second end of the grip part at least to a position beyond the center position, in the first direction. Thus, the length of the operation member may be larger than half the length of the grip part in the first direction. According to this embodiment, the operation member is provided that can be easily operated by a user holding the grip part whether in the normal orientation or in the reverse orientation. Further, the operation member may be supported by the grip part to be rotatable around one end part of the operation member in a longitudinal direction. In this case, the relatively long operation member can be more reliably moved by manual operation whether in the normal orientation or in the reverse orientation.

In addition or in the alternative to the preceding embodiments, the driving mechanism may include an intermediate shaft, an oscillating member and a piston. The intermediate shaft may be operably connected to the output shaft and rotated around a second rotational axis with rotation of the output shaft. The oscillating member may be arranged on the intermediate shaft and oscillated in the front-rear direction with rotation of the intermediate shaft. The piston may be operably connected to the oscillating member and linearly reciprocated along the driving axis with oscillation of the oscillating member. The driving axis, the first rotational axis and the second rotational axis may be parallel to each other. The handle may protrude from the tool body in a direction toward the second rotational axis. According to this embodiment, one part of the tool body that is located on the opposite side from the oscillating member and the handle relative to the driving axis can be formed smaller than the other part of the tool body that is located on the same side as the oscillating member and the handle. Thus, when the power tool is used in an attitude in which the handle protrudes in a direction away from a working surface of the workpiece, the angle formed between the driving axis and the working surface of the workpiece can be made smaller than a structure in which the handle protrudes from the tool body in the opposite direction. This improves the workability in an operation such as peeling off.

In addition or in the alternative to the preceding embodiments, the first rotational axis of the output shaft of the motor may be arranged between the driving axis and the second rotational axis of the intermediate shaft in the first direction. According to this embodiment, the size of the tool body in the first direction can be reduced compared with a structure in which the second rotational axis of the intermediate shaft is arranged between the driving axis and the first rotational axis of the output shaft.

In addition or in the alternative to the preceding embodiments, the power tool having a hammer mechanism may further have a battery mounting part to which a battery is removably mounted. The driving axis may pass through the battery mounting part when the power tool is viewed from a second direction orthogonal to the front-rear direction and the first direction. According to this embodiment, when using the power tool while holding the grip part in the reverse orientation, a user can obtain similar operability and usability to those obtained when using the power tool while holding the grip part in the normal orientation.

In addition or in the alternative to the preceding embodiments, the battery mounting part may include an engagement part that is configured to be slidingly engaged with the battery in a direction crossing the driving axis. A general battery has a rectangular parallelepiped shape and is slid in a longitudinal direction of the battery relative to the battery mounting part. According to this embodiment, the whole length of the tool body with the battery mounted thereon can be reduced, compared with a structure in which the sliding direction is parallel to the driving axis. Further, the engagement part may be configured to be slidingly engaged with the battery in the first direction. In this case, the longitudinal direction of the battery corresponds to the first direction (the extending direction of the grip part). Thus, the battery is prevented from protruding from the tool body in a direction orthogonal to the driving axis and the first direction.

In addition or in the alternative to the preceding embodiments, the battery mounting part may be arranged behind the grip part in the front-rear direction. The battery mounting part may be configured such that the battery mounted to the battery mounting part is located on a side opposite to the second end of the grip part in the first direction relative to a region behind the grip part where the user places a hand when holding the grip part. According to this embodiment, the battery mounting part is arranged to prevent interference of the battery with a user holding the grip part.

Representative, non-limiting embodiments of the present disclosure are now specifically described with reference to the drawings.

### First Embodiment

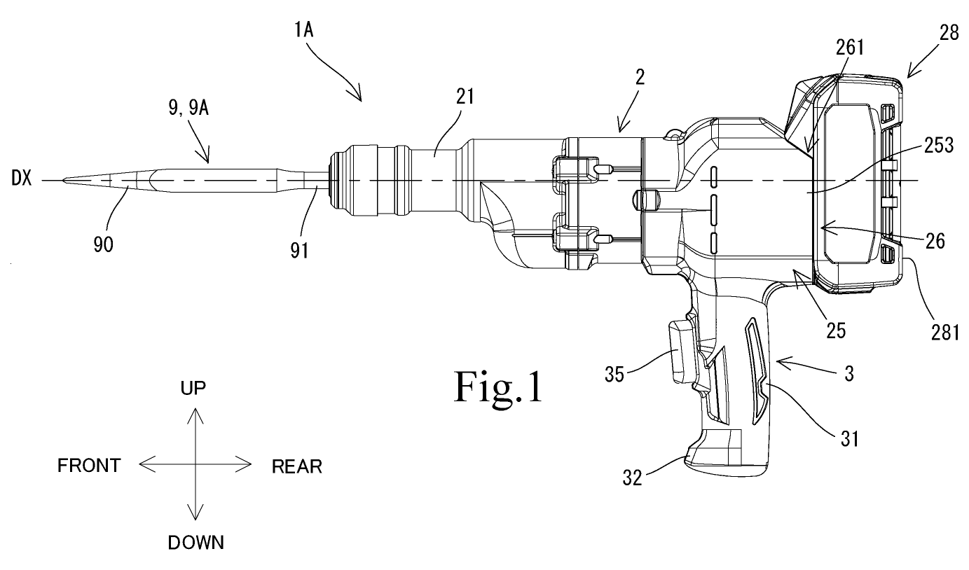

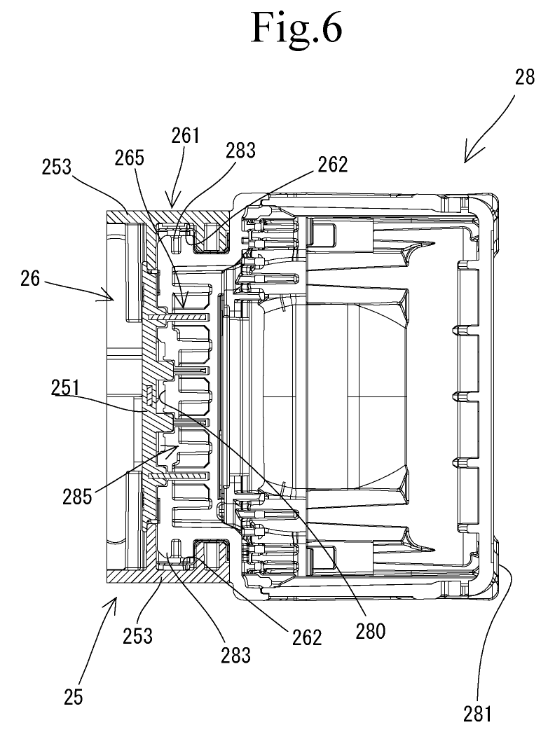

A power tool having a hammer mechanism 1A according to a first embodiment of the present disclosure is now described with reference to FIGS. 1 to 11. The power tool having a hammer mechanism 1A (hereinafter simply referred to as a power tool 1A) is a relatively small portable power tool. The power tool 1A is configured to apply hammering force to a tool accessory 9 mounted thereto and linearly drive the tool accessory 9 along a driving axis DX. Various kinds of tool accessories 9 suitable for various machining operations are provided for the power tool 1A and can be selectively mounted to the power tool 1A. When using the power tool 1A, a user can select a tool accessory 9 suitable for an intended operation from the variety of tool accessories 9 and mount it to the power tool 1A. Thus, the power tool 1A is also called as a multi-hammer.

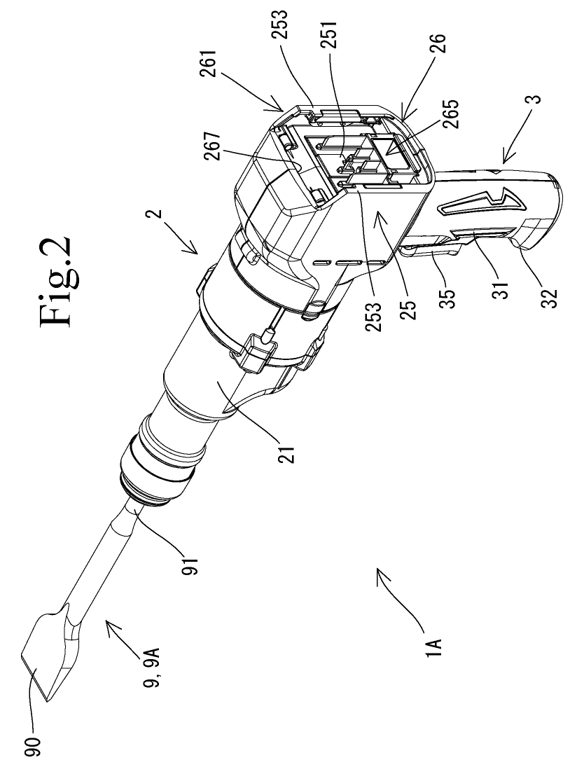

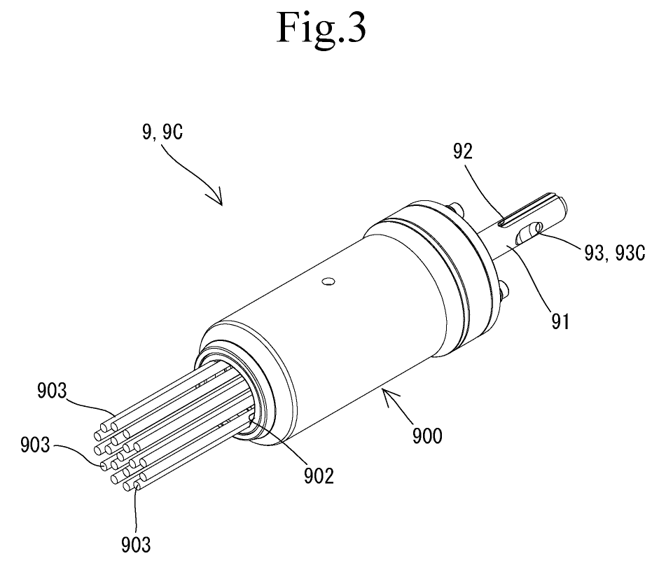

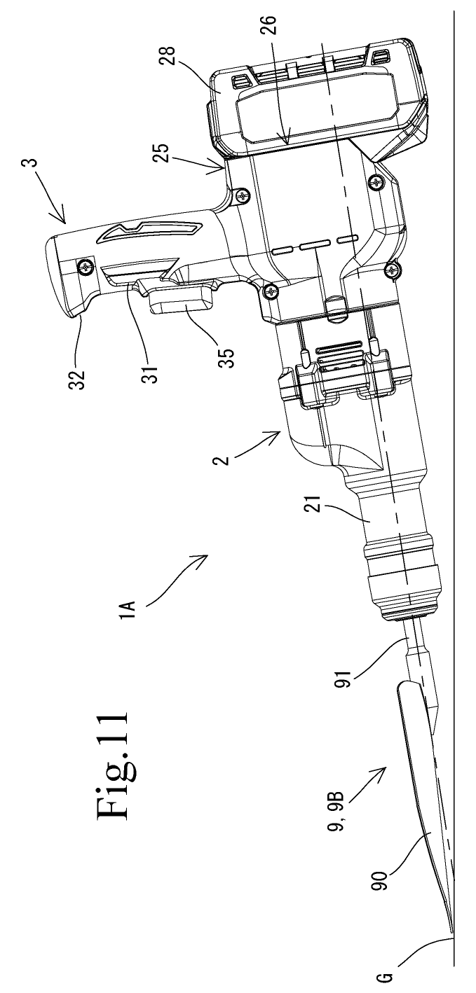

In FIGS. 1 and 2, a chisel bit 9A suitable for chipping is shown as an example of the tool accessories 9 that can be mounted to the power tool 1A. Other non-limiting examples of the tool accessories 9 that can be mounted to the power tool 1A include a scoop 9B (see FIG. 11) suitable for digging, a needle scaler 9C (see FIG. 3) suitable for removing foreign materials on a surface of a workpiece and grinding the surface, a bull point (not shown) suitable for crushing, and a scraper (not shown) suitable for peeling. All of the tool accessories 9 have a shank 91 that can be mounted to the power tool 1A.

The chisel bit 9A has a blade 90 having a shape suitable for chipping operation, and the shank 91 that is formed integrally with the blade 90 or fixed to the blade 90. The scoop 9B (see FIG. 11) and the bull point and the scraper (which are not shown) also have the same. Machining operation is performed when hammering force is applied to the shank 91 and transmitted to a workpiece via the blade 90.

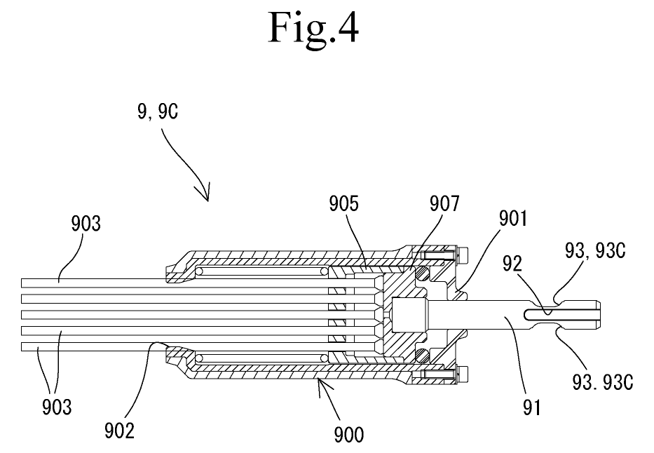

As shown in FIGS. 3 and 4, the needle scaler 9C has a circular cylindrical, bottomed housing 900, needles 903, a holder 905 for supporting the needles 903, and an anvil 907. The holder 905 is housed in the housing 900 so as to be slidable in an axial direction of the housing 900 and configured to support the needles 903 to be movable in the axial direction. The anvil 907 is housed in the housing 900 so as to be slidable in the axial direction of the housing 900 and in contact with one end of the holder 905. The shank 91 is slidably inserted through an opening of a bottom 901 of the housing 900. One end part of the shank 91 that is inserted into the housing 900 is fixed to the anvil 907. The needles 903 protrude from an opening 902 of the housing 900 on the opposite side from the bottom 901. The needles 903 supported by the holder 905 move in the axial direction when hammering force is applied to the anvil 907 and thus to the holder 905 via the shank 91. Foreign materials on a surface of a workpiece are removed by tips of the needles 903 finely moving in contact with the workpiece.

First, the structure of the power tool 1A is described in brief.

As shown in FIGS. 1, 2 and 5, an outer shell of the power tool 1A is defined by a tool body 2 extending in the driving axis DX and an elongate handle 3 protruding from the tool body 2 in a direction crossing the driving axis DX.

The tool body 2 houses a tool holder 41 that detachably holds the tool accessory 9, a motor 51, and a driving mechanism 6 that is operably connected to the motor 51 and configured to linearly drive the tool accessory 9 held by the tool holder 41 when the motor 51 is driven. The tool holder 41 is fixed within one end part of the tool body 2 in the extending direction of the driving axis DX. The tool holder 41 is configured to hold the tool accessory 9 so as to be movable along the driving axis DX and not to be rotatable around the driving axis DX, relative to the tool holder 41. The driving mechanism 6 is configured to convert rotational power of the motor 51 into linear motion and apply hammering force to the tool accessory 9 held by the tool holder 41.

The handle 3 is a so-called pistol grip and is connected to the tool body 2 in a cantilever manner. Specifically, one end of the handle 3 in a longitudinal direction is connected as a base end to the tool body 2, and the other end is a free end. In this embodiment, the handle 3 extends in a direction substantially orthogonal to the driving axis DX, from an end part of the tool body 2 on the opposite side from the tool holder 41 in the extending direction of the driving axis DX. The handle 3 includes a grip part 31 configured to be held by a user, and a trigger 35 that is operated by a user to start the motor 51. When the trigger 35 is depressed, the motor 51 is driven, and the tool accessory 9 is driven by the driving mechanism 6.

The structure of the power tool 1A is now described in detail. In the following description, for convenience sake, the extending direction of the driving axis DX is defined as a front-rear direction of the power tool 1A. In the front-rear direction, the side of the tool holder 41 is defined as the front side of the power tool 1A, and the opposite side (on which the handle 3 is connected) is defined as the rear side of the power tool 1A. A direction orthogonal to the driving axis DX and corresponding to the extending direction of the handle 3 is defined as an up-down direction of the power tool 1A. The up-down direction of the power tool 1A is not synonymous with a vertical direction. In the up-down direction, the side of the base end of the handle 3 is defined as an upper side of the power tool 1A, and the opposite side (the side of the free end) is defined as a lower side of the power tool 1A. A direction orthogonal to the front-rear direction and the up-down direction of the power tool 1A is defined as a left-right direction of the power tool 1A.

The structure of the tool body 2 is now described.

As shown in FIGS. 1, 2 and 5, the tool body 2 is a hollow body extending along the driving axis DX. A front part of the tool body 2 is also referred to as a barrel part 21, and has a circular cylindrical shape having a smaller diameter than a rear part of the tool body 2 extending rearward from the barrel part 21. The barrel part 21 extends along the driving axis DX. A user can use an auxiliary handle (not shown) that can be removably attached to the barrel part 21. Alternatively, a user can hold the handle 3 by one hand and auxiliarily hold the barrel part 21 by the other hand. The tool holder 41 is housed in the barrel part 21. The motor 51, a controller 50 and the driving mechanism 6 are housed in the rear part extending rearward from the barrel part 21.

As shown in FIGS. 2, 5 and 6, a rear end part 25 of the tool body 2 has a rectangular box-like shape. Left and right side wall parts 253 of the rear end part 25 protrude rearward of a rear wall part 251 of the tool body 2. In this embodiment, the rear wall part 251 has a generally rectangular shape and has a rear surface substantially orthogonal to the driving axis DX. In other embodiments, however, the rear wall part 251 may be inclined relative to the driving axis DX. A battery mounting part 26 to which a battery 28 can be mounted is provided in the rear end part 25 of the tool body 2.

The battery 28 is a rechargeable battery (also referred to as battery pack) and can be mounted to plural kinds of power tools including the power tool 1A. The battery 28 has a generally rectangular parallelepiped (hexahedral) shape. A pair of guide rails 283 and a connector part 285 having terminals are provided on one surface (hereinafter referred to as a mounting surface 280) of the battery 28. The guide rails 283 protrude from the mounting surface 280 and extend parallel to each other in a longitudinal direction of the battery 28. The connector part 285 is arranged between the guide rails 283. A direction in which the guide rails 283 substantially face each other defines a width direction of the battery 28. A direction substantially orthogonal to the mounting surface 280 defines a height direction of the battery 28.

The battery mounting part 26 includes an engagement part 261 that can be physically engaged with the battery 28, and a connector part 265 that can be electrically connected to the battery 28. The engagement part 261 includes a pair of guide grooves 262 respectively formed in the side wall parts 253. The guide grooves 262 are long linear grooves respectively formed in inner surfaces of the side wall parts 253. The guide grooves 262 extend downward in the up-down direction in parallel to each other from an upper end of the side wall parts 253. The guide grooves 262 are configured to be slidingly engaged with the guide rails 283 of the battery 28. The connector part 265 is arranged on the rear wall part 251 (between the guide grooves 262). The connector part 265 includes terminals that can be respectively electrically connected to the terminals of the battery 28.

In order to mount the battery 28 to the battery mounting part 26, the guide rails 283 of the battery 28 are fitted into the guide grooves 262 of the battery mounting part 26 from above, while the battery 28 is held with the guide rails 283 extending in the up-down direction of the power tool 1A. Specifically, in this embodiment, a direction of mounting the battery 28 to the battery mounting part 26 substantially corresponds to the downward direction of the power tool 1A. When the battery 28 is slid downward to a prescribed mounting position, the connector part 285 (the terminals) of the battery 28 is electrically connected to the connector part 265 (the terminals) and mounting of the battery 28 is completed.

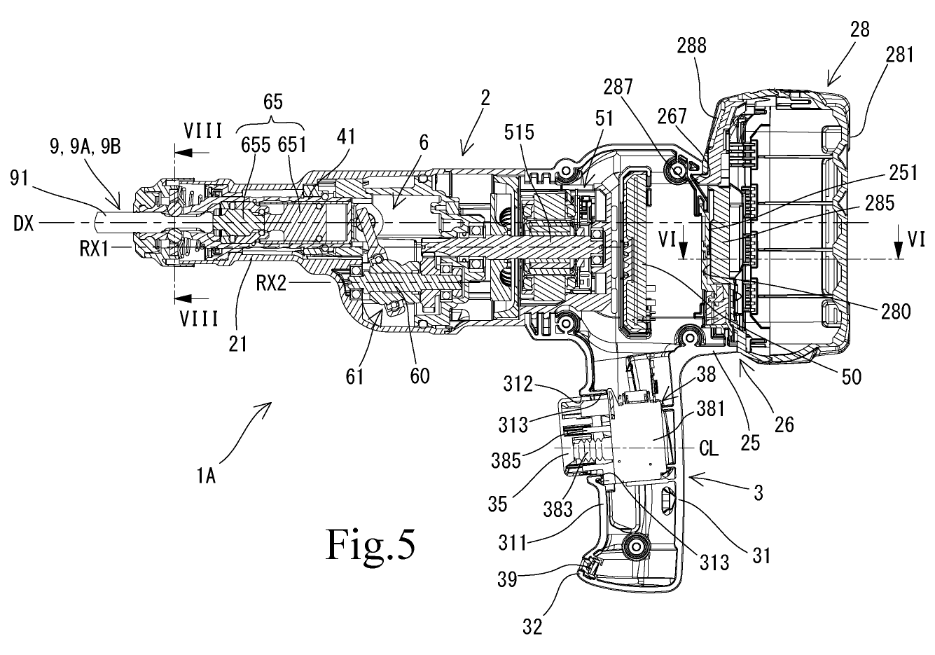

A recessed part 267 is formed in an upper end part of the battery mounting part 26 (above the connector part 265) and configured to be engaged with a locking member 287 (see FIG. 5) provided on the mounting surface 280 of the battery 28. When the battery 28 is placed at the mounting position, the locking member 287 is engaged with the recessed part 267 and restricts movement of the battery 28 in the up-down direction relative to the battery mounting part 26.

When the battery 28 is mounted to the battery mounting part 26, the rear wall part 251 faces the mounting surface 280 of the battery 28. In this embodiment, the driving axis DX passes through the battery mounting part 26 (specifically, the rear wall part 251) and the battery 28. Specifically, the driving axis DX passes through the battery mounting part 26 (specifically, the rear wall part 251) and the battery 28, when the power tool 1A is viewed from a direction orthogonal to the driving axis DX and a longitudinal axis of the handle 3 (the grip part 31) (specifically, from the left or right) (see FIG. 5). Further, the driving axis DX also passes through the battery mounting part 26 and the battery 28, when the power tool 1A is viewed from the longitudinal direction of the handle 3 (specifically, from above or below). In this embodiment, the driving axis DX passes through the centers of the battery mounting part 26 and the battery 28 in the left-right direction.

In order to remove the battery 28 from the battery mounting part 26, a release button 288 (see FIG. 5), which is provided adjacent to the locking member 287 on the battery 28, is depressed to disengage the locking member 287 from the recessed part 267. Subsequently, the battery 28 is lifted upward and removed while the guide rails 283 are slid in the guide grooves 262. Specifically, in this embodiment, a direction of removing the battery 28 from the battery mounting part 26 is defined as the upward direction of the power tool 1A.

In this embodiment, the guide grooves 262 of the battery mounting part 26 extend in the up-down direction, and thus the longitudinal direction of the battery 28 placed in the mounting position substantially corresponds to the up-down direction of the power tool 1A. Therefore, the whole length of the tool body 2 with the battery 28 mounted thereon in the front-rear direction can be reduced, compared with a structure in which the guide grooves 262 extend in the front-rear direction in parallel to the driving axis DX. Further, the guide grooves 262 are arranged in symmetry to a plane including the driving axis DX and the longitudinal axis of the handle 3, and the mounted battery 28 also has a substantially symmetrical shape to the plane. Thus, the tool body 2 with the battery 28 mounted thereto is well-balanced in the left-right direction.

Further, the guide grooves 262 are configured to receive the battery 28 from above. Thus, the battery 28 placed in the mounting position relatively greatly protrudes upward from the battery mounting part 26, but little protrudes downward from the battery mounting part 26. Various kinds of batteries 28 different in size (particularly, length and height) can be mounted to the battery mounting part 26. The amount of upward protrusion of the batteries 28 from the battery mounting part 26 is different according to the kind of the batteries 28, but any battery 28 little protrudes downward from the battery mounting part 26.

Elements (mechanisms) disposed within the tool body 2 are now described.

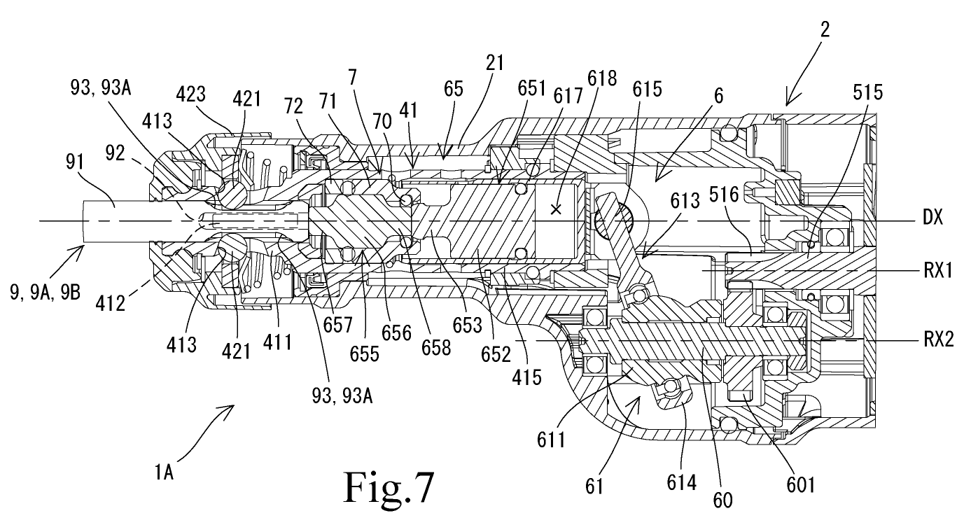

As shown in FIG. 7, the tool holder 41 is arranged in the barrel part 21 and extends along the driving axis DX. The tool holder 41 is a circular cylindrical member configured to removably hold the tool accessory 9. More specifically, the tool holder 41 is a circular cylindrical, stepped member and has a small-diameter part 411 and a large-diameter part 415 having a larger diameter than the small-diameter part 411. The small-diameter part 411 is a front end part of the tool holder 41 and is configured to receive the shank 91 of the tool accessory 9 and hold the shank 91 so as to be slidable along the driving axis DX. The large-diameter part 415 houses a piston cylinder 617, a striking element 65 and an idle-driving prevention mechanism 7, which are described below.

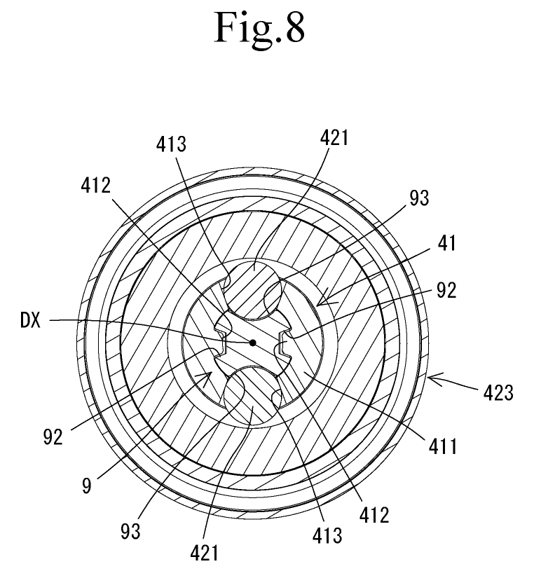

As shown in FIGS. 7 and 8, two protrusions 412 for torque transmission are formed on the small-diameter part 411. The protrusions 412 protrude radially inward from an inner circumferential surface of the small-diameter part 411 and extend substantially in parallel to the driving axis DX (i.e. in the front-rear direction). The protrusions 412 are arranged oppositely to each other across the driving axis DX.

The small-diameter part 41 has two slots 413. The slots 413 are through holes formed through the small-diameter part 41 in the radial direction and extend substantially in parallel to the driving axis DX (i.e. in the front-rear direction). The slots 413 are arranged oppositely to each other across the driving axis DX. Each of the slots 413 holds a ball 421, which is provided to prevent slipping-off of the tool accessory 9, so as to be slidable in the front-rear direction within the slot 413. A chuck cover 423 is fitted onto the tool holder 41 so as to be slidable in the front-rear direction. Although the structure of the chuck cover 423 is well known and therefore not described in detail herein, the chuck cover 423 is normally held in an initial position and holds the balls 421 so as to protrude radially inward of the small-diameter part 411 from the slots 413.

All of the shanks 91 of the tool accessories 9 (regardless of the kind of the tool accessories 9) that can be used for the power tool 1A have substantially the same diameter and have two long grooves 92 corresponding to the two projections 412 of the small-diameter part 411. The long grooves 92 extend in the axial direction from an end of the shank 91 (which is also referred to as a rear end of the shank 91, from which the shank 91 is inserted into the tool holder 41). The shank 91 is inserted into the small-diameter part 411 with the long grooves 92 engaged with the projections 412.

Further, all of the shanks 91 of the tool accessories 9 that can be used for the power tool 1A have two recesses 93. The recesses 93 are arranged oppositely to each other across the driving axis DX and apart from the rear end of the shank 91 in the axial direction of the tool accessory 9. Each of the recesses 93 has a section of a generally circular arc shape conforming to the shape of the ball 421, and extends in the axial direction of the tool accessory 9. When the shank 91 of the tool accessory 9 is inserted into the small-diameter part 411 as described above, the shank 91 is held while part of the ball 421 protrudes into the recess 93. Thus, the tool accessory 9 is prevented from slipping off the tool holder 41, and mounting of the tool accessory 9 is completed.

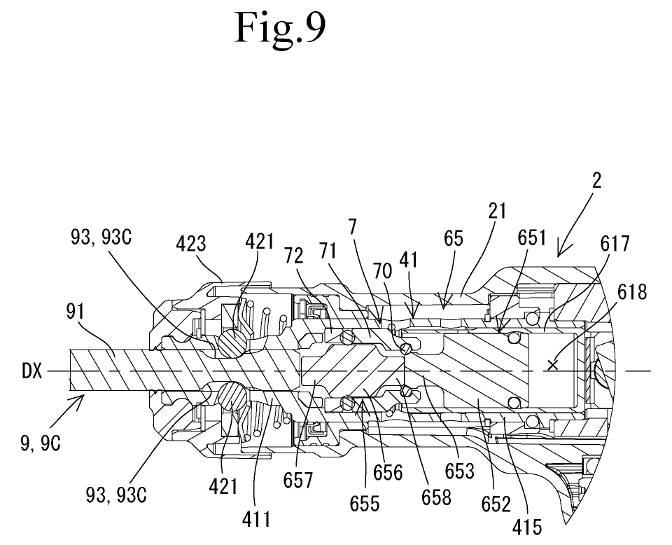

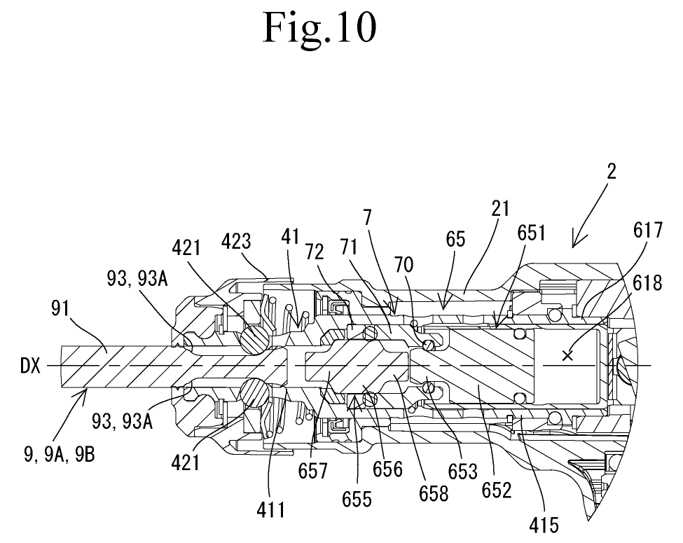

The length of the recess 93 of the tool accessory 9 in the axial direction is set such that the ball 421 can move in the front-rear direction in the recess 93 so as to allow the tool accessory 9 to slide in the front-rear direction relative to the tool holder 41. As shown in FIGS. 9 and 10, however, the length of the recess 93 is different among the tool accessories 9 that can be mounted to the power tool 1A, or specifically between the needle scaler 9C (see FIG. 3) and other tool accessories 9 (such as the chisel bit 9A (see FIG. 2) and the scoop 9B (see FIG. 11)). In the following description, as for the recess 93 of the tool accessory 9, the recess 93 of the needle scaler 9C is specifically referred to as a recess 93C, and the recess 93 of any other tool accessories 9 is specifically referred to as a recess 93A.

More specifically, in any of the tool accessories 9, a front end of the recess 93 in the axial direction of the shank 91, which is farther from the rear end of the shank 91 than a rear end of the recess 93, is located at the same position in the axial direction of the shank 91. On the other hand, a rear end of the recess 93C of the needle scaler 9C is located further apart (forward) from the rear end of the shank 91 than a rear end of the recess 93A of any of the other tool accessories 9. Thus, the recess 93C of the needle scaler 9C is shorter than the recess 93A of any of the other tool accessories 9.

With such configuration, the rear end of the shank 91 of the needle scaler 9C placed in a frontmost position relative to the tool holder 41 (see FIG. 9) is located further rearward than the rear end of the shank 91 of any of the other tool accessories 9 placed in a frontmost position (see FIG. 10). The recesses 93 are made different in length in order to prevent the idle-driving prevention mechanism 7 from functioning when an operation is performed with the needle scaler 9C mounted to the tool holder 41, which will be described in detail below.

As shown in FIG. 5, the motor 51 is arranged within the rear part of the tool body 2. A rotational axis RX1 of an output shaft 515 of the motor 51 extends in parallel to the driving axis DX (i.e. in the front-rear direction). More specifically, the rotational axis RX1 extends below the driving axis DX. In this embodiment, the motor 51 is a brushless DC motor, but in other embodiments, the motor 51 may be a brush motor.

The controller 50 is arranged behind the motor 51 within the tool body 2. The controller 50 includes at least one processor (such as a CPU) or processing circuit and controls operation of the power tool 1A. In this embodiment, the controller 50 controls driving of the motor 51 and driving of a lighting unit 39 described below.

The driving mechanism 6 is arranged in front of the motor 51 within the tool body 2. The driving mechanism 6 includes an intermediate shaft 60, a motion converting mechanism 61 and a striking element 65.

As shown in FIG. 7, the intermediate shaft 60 is supported within a central part of the tool body 2 so as to be rotatable around a rotational axis RX2 that is parallel to the rotational axis RX1 of the output shaft 515. More specifically, the rotational axis RX2 of the intermediate shaft 60 extends below the rotational axis RX1 of the output shaft 515. With such arrangement, the distance (so-called center height) between the driving axis DX and an upper surface of the tool body 2 can be made significantly shorter than the distance between the driving axis DX and a lower surface of the tool body 2. In this embodiment, the driving axis DX and the rotational axes RX1, RX2 are arranged on a plane that substantially divides the tool body 2 into two halves in the left-right direction.

The intermediate shaft 60 is operably connected to the output shaft 515 of the motor 51. More specifically, a pinion 516 is formed in a front end part of the output shaft 515. A gear 601 is fixedly fitted onto a rear end part of the intermediate shaft 60 and engaged with the pinion 516. Thus, the intermediate shaft 60 is rotated with rotation of the output shaft 515.

The motion converting mechanism 61 includes a rotary body 611 that is arranged on the intermediate shaft 60, an oscillating member 613 that is operably connected to the rotary body 611, and a piston cylinder 617 that is operably connected to the oscillating member 613.

The rotary body 611 is fitted onto the intermediate shaft 60 so as to be integrally rotated with the intermediate shaft 60. The oscillating member 613 includes a ring part 614 that is fitted onto the rotary body 611, and an arm part 615 extending from the ring part 614. The rotary body 611 and the oscillating member 613 are configured such that the arm part 615 is oscillated in the front-rear direction with rotation of the intermediate shaft 60 and the rotary body 611. In this embodiment, the rotary body 611 and the oscillating member 613 are connected via rolling elements and integrally formed as an assembly that is called a swash bearing, a wobble bearing or a wobble plate. The rotary body 611 and the oscillating member 613 can however be appropriately changed in structure, provided that rotation of the intermediate shaft 60 can be converted into linear motion in the front-rear direction and transmitted to the piston cylinder 617. For example, the rotary body 611 may be integrally formed with the intermediate shaft 60.

The piston cylinder 617 is a circular cylindrical, bottomed member. The piston cylinder 617 is arranged with an opening facing forward within the large-diameter part 415 of the tool holder 41 and configured to slide within the large-diameter part 415 along the driving axis DX. A rear end part of the piston cylinder 617 is operably connected to the arm part 615 of the oscillating member 613. Thus, the piston cylinder 617 is reciprocated in the front-rear direction with oscillation of the arm part 615.

The striking element 65 is configured to strike the tool accessory 9 to thereby linearly drive the tool accessory 9 with reciprocating movement of the piston cylinder 617. In this embodiment, the striking element 65 includes a striker 651 and an impact bolt 655.

The striker 651 is arranged within the piston cylinder 617 so as to be slidable along the driving axis DX. The striker 651 includes a cylindrical body part 652 and a small-diameter part 653 that has a smaller diameter than the body part 652 and protrudes forward from the body part 652. A space between the bottom of the piston cylinder 617 and the striker 651 defines an air chamber 618 that functions as an air spring. The striker 651 is reciprocatingly slid within the piston cylinder 617 by pressure fluctuations caused in the air chamber 618 by the reciprocating movement of the piston cylinder 617.

The impact bolt 655 is an intermediate element that transmits the kinetic energy of the striker 651 to the tool accessory 9. The impact bolt 655 is arranged in front of the striker 651 within the large-diameter part 415 of the tool holder 41 so as to be slidable along the driving axis DX. The impact bolt 655 is a cylindrical, stepped member and has a large-diameter part 656 formed in a substantially central part in the front-rear direction, and small-diameter parts 657 and 658 respectively protruding forward and rearward from the large-diameter part 656. In this embodiment, the large-diameter part 656 of the impact bolt 655 is held to be slidable in the front-rear direction by cylindrical first and second sleeves 71, 72 that are fitted into the large-diameter part 415 of the tool holder 41 with the second sleeve 72 arranged in front of the first sleeve 71.

The idle-driving prevention mechanism 7 is configured to prevent idle driving. Preventing idle driving means stopping the reciprocating movement of the striker 651 when the tool accessory 9 is not mounted to the tool holder 41, or when the tool accessory 9 is not pressed onto a workpiece, that is to say, in a state where no load is applied to the striking element 65 (hereinafter referred to as a no-load state).

In this embodiment, the idle-driving prevention mechanism 7 is configured to stop the reciprocating movement of the striker 651 by catching the small-diameter part 653 of the striker 651 when the striker 651 is moved forward in the no-load state. More specifically, the idle-driving prevention mechanism 7 includes the first sleeve 71 and an O-ring 70. The first sleeve 71 is fitted into a front end part of the large-diameter part 415 as described above. The O-ring 70 is fitted in a rear end part of the first sleeve 71.

As shown in FIG. 7, in a state where the tool accessory 9 is mounted to the tool holder 41 and pressed onto a workpiece, that is to say, in a state (hereinafter referred to as a loaded state) where load is applied to the striking element 65, the impact bolt 655 is pushed in to a position (hereinafter referred to as a rear end position) where a shoulder part of the large-diameter part 656 abuts on a shoulder part of the inside of the first sleeve 71. As described above, in any of the tool accessories 9 including the needle scaler 9C, the front end of the recess 93 in the axial direction is located at the same position. Thus, even if any of the various kinds of tool accessories 9 is mounted to the tool holder 41, the impact bolt 655 in the loaded state is located at the same position. In the rear end position, the rear small-diameter part 658 of the impact bolt 655 is located inside the O-ring 70.

When the motor 51 is driven in the loaded state, the striker 651 strikes the impact bolt 655. The impact bolt 655 transmits the kinetic energy of the striker 651 to the tool accessory 9 and linearly drives the tool accessory 9. The tool accessory 9 is continued to be driven when the striker 651 continues to reciprocate and strike the impact bolt 655 in the rear end position.

As shown in FIG. 10, in the no load state, where the tool accessory 9 other than the needle scaler 9C is mounted to the tool holder 41, when the tool accessory 9 is moved to a position (frontmost position) where the balls 421 abut on the rear end of the recess 93A, the striker 651 is allowed to move forward to a position where the small-diameter part 653 is fitted into the O-ring 70. Thus, when the motor 51 is continued to be driven in this state, the small-diameter part 653 of the striker 651 is pushed forward by the action of the air spring and caught by the O-ring 70, so that the striker 561 is held at the position. Thus, the striker 561 stops reciprocating. Thereafter, as shown in FIG. 7, when the tool accessory 9 is pressed onto a workpiece and the impact bolt 655 is pushed in to the rear end position, the small-diameter part 653 is released from the O-ring 70, and the striker 651 starts reciprocating.

As shown in FIG. 9, in the no load state, where the needle scaler 9C is mounted to the tool holder 41, even if the needle scaler 9C is moved to a position (frontmost position) where the balls 421 abut on the rear end of the recess 93C, a rear end of the impact bolt 655 is located inside the O-ring 70. Thus, the striker 651 is not allowed to move forward to a position where the small-diameter part 653 is fitted into the O-ring 70. Thus, when the motor 51 is continued to be driven, the striker 651 continues to strike the impact bolt 655, and the needle scaler 9C is continued to be driven.

In this manner, the recess 93C of the needle scaler 9C is configured to prevent the idle-driving prevention mechanism 7 from functioning. This is because, in the operation of removing foreign materials on a surface of a workpiece, the needle scaler 9C is not pressed hard onto the workpiece (the needle scaler 9C is normally in the no load state) such that the tips of the needles 903 can be moved in contact with the workpiece.

In other embodiments, the idle-driving prevention mechanism 7 may be omitted, or a mechanism for preventing idle driving in any other way may be adopted.

The handle 3 and elements (mechanisms) disposed therein are now described.

As shown in FIG. 5, the handle 3 is an elongate hollow body including the grip part 31. The grip part 31 has a diameter suitable for a user to hold, and has a length slightly longer than the average width of a hand of an adult male. In this embodiment, the whole handle 3 except for a lower end part 32 forms the grip part 31.

The handle 3 of this embodiment extends downward from a lower end of a part of the tool body 2 that is located slightly forward of the battery mounting part 26 in the front-rear direction. Thus, the handle 3 is arranged on the same side as the rotational axis RX1 of the output shaft 515 and the rotational axis RX2 of the intermediate shaft 60 relative to the driving axis DX in the up-down direction. Further, in this embodiment, the handle 3 is arranged rearward of the stator of the motor 51 and the driving mechanism 6 and forward of the battery mounting part 26 in the front-rear direction. The controller 50 is arranged in a region right above the grip part 31 within the tool body 2.

As described above, in this embodiment, the battery 28 mounted to the battery mounting part 26 little protrudes downward from the battery mounting part 26. An area just below the battery 28 and just behind the grip part 31 is secured as a space area (where nothing exists) for a hand of the user to hold the grip part 31.

The lower end part 32 of the handle 3 slightly protrudes forward from the grip part 31. The lighting unit 39 is arranged in this protruding part. The lighting unit 39 includes a light source (such an LED) and is supported by the lower end part 32 to illuminate a working area of the tool accessory 9 (i.e. an area in front of the barrel part 21). Specifically, the lighting unit 39 is arranged to illuminate diagonally forward and upward through an opening formed in the lower end part 32.

The trigger 35 is arranged on the front side of the grip part 31. The trigger 35 is a manual operation member that is configured to be depressed by a user to start the motor 51. In this embodiment, the trigger 35 is arranged in a region including a center position CL of the grip part 31 in the longitudinal direction (substantially in the up-down direction of the power tool 1A). The center position CL is a position substantially equidistant from both ends (i.e. an upper end close to the tool body 2, which is also the base end of the handle 3, and a lower end close to the free end of the handle 3) of a front surface of the grip part 31 in the longitudinal direction of the grip part 31. More specifically, the trigger 35 is arranged in a central region of the grip part 31 in the longitudinal direction and apart from the upper and lower ends of the front surface of the grip part 31. This central region is a region including the center position CL of the grip part 31 in the longitudinal direction.

The trigger 35 of this embodiment is supported by the grip part 31 so as to be linearly slidable substantially in the front-rear direction (the extending direction of the driving axis DX). More specifically, an opening 312 is formed in a front wall part 311 that defines the front surface of the grip part 31. The trigger 35 is arranged to partially protrude from the front wall part 311 through the opening 312. A switch 38 is arranged just behind the trigger 35 within the grip part 31. The trigger 35 can be moved in the front-rear direction while sliding on plate-like guides 313 that protrude rearward from the front wall part 311 on the upper and lower sides of the opening 312, respectively, and sliding on a plate-like guide 385 formed on the switch 38.

The switch 38 is configured to be turned on and off according to the depressing operation of the trigger 35. The switch 38 of this embodiment has a switch body 381 and a plunger 383 biased forward and protruding forward from the switch body 381. A protruding end of the plunger 383 is held in contact with the trigger 35. The switch 38 is configured to be normally kept off, and turned on when the plunger 383 is pushed into the switch body 381. The switch 38 is electrically connected to the controller 50.

In an initial state in which the trigger 35 is biased forward by the plunger 383 and not subjected to rearward external force, the trigger 35 is held in a frontmost position. When the trigger 35 is located in the frontmost position, the switch 38 is in an off state. When the trigger 35 is depressed and slid rearward to a prescribed position while pushing in the plunger 383, the switch 38 is tuned on. In this embodiment, the controller 50 drives the motor 51 while the switch 38 is in an on state.

As described above, the power tool 1A of this embodiment has the handle 3 that protrudes in a direction crossing the driving axis DX from the tool body 2 extending along the driving axis DX. The trigger 35 is configured to be depressed to instruct start of the motor 51 and arranged in a region including the center position CL of the grip part 31 in the longitudinal direction. Thus, the trigger 35 can be easily depressed with one or more fingers of a user, whether the user holds the grip part 31 in an orientation with a thumb on the upper end side (the tool body 2 side) of the grip part 31 (hereinafter referred to as a normal orientation), or in an orientation with the thumb on the lower end side (the lower end part 32 side) of the grip part 31 (hereinafter referred to as a reverse orientation).

In a conventional power tool, the trigger is arranged in the upper end part of the grip part. This arrangement is suitable for a user to hold the grip part in the normal orientation and depress the trigger with a forefinger. When holding the grip part in the reverse orientation, however, the user needs to depress the trigger with a little finger, so that it is difficult to apply a sufficient depressing force to the trigger. In the power tool 1A of this embodiment, the user can apply substantially equal depressing force to the trigger 35 whether the grip part 31 is held in the normal orientation or in the reverse orientation.

Further, the trigger 35 is arranged apart from the upper and lower ends of the grip part 31 and supported to be slidable in the front-rear direction. Thus, with a simple structure, the trigger 35 is provided that can be easily operated by a user holding the grip part 31 whether in the normal orientation or in the reverse orientation.

The power tool 1A can be used in various attitudes. Specifically, the side on which the handle 3 is placed relative to the driving axis DX in the vertical direction, and the angle of the driving axis DX relative to a working surface of a workpiece can be changed according to the kind of machining and the position and angle of the working surface. In the power tool 1A of this embodiment, as described above, the orientation in which the grip part 31 is held does not substantially affect the operability of the trigger 35. Thus, the power tool 1A exhibits superior operability in various attitudes as described in the following non-limiting examples.

For example, in an operation of crushing a wall surface in front of a user, the user can hold the grip part 31 in the normal orientation, or hold the power tool 1A in an attitude (hereinafter referred to as a normal attitude) in which the handle 3 is placed below the driving axis DX in the vertical direction and protrudes downward (or obliquely downward). Alternatively, the user can hold the grip part 31 in the reverse orientation, or hold the power tool 1A in an attitude (hereinafter referred to as an inverted attitude) in which the handle 3 is placed above the driving axis DX in the vertical direction and protrudes upward (or obliquely upward).

In an operation of digging the ground G and scooping soil with the scoop 9B, as shown in FIG. 11, it is preferable that an angle formed between the ground G and the driving axis DX is made as much as small. Accordingly, the user can easily perform the operation by holding the power tool 1A in the inverted attitude and holding the grip part 31 in the reverse orientation. The same is true for a peeling-off operation on a workpiece by using the chisel bit 9A or a scraper, and an operation of removing foreign materials on a surface of a workpiece by using the needle scaler 9C.

Further, in the power tool 1A, the battery mounting part 26 is arranged in the rear end part 25 of the tool body 2 such that the driving axis DX passes through the battery mounting part 26 and the battery 28. With this arrangement, compared with a conventional power tool in which the battery is mounted to the lower end of the handle, the power tool 1A is improved in operability and/or workability when used in various attitudes, as described in the following.

Firstly, when using the power tool 1A while holding the grip part in the reverse orientation, a user can obtain similar operability and usability to those obtained when using the power tool 1A while holding the grip part in the normal orientation. Specifically, when a conventional power tool is used in the reverse orientation, a relatively heavy battery is located above the driving axis DX in the vertical direction, so that user’s operation is made unstable. The power tool 1A of this embodiment can however be stably operated even in the inverted attitude. In this embodiment, the grip part 31 extends in a direction substantially orthogonal to the driving axis DX. This arrangement also helps realize similar operability and usability in the reverse orientation to those in the normal orientation.

Secondly, when the power tool 1A is used in the attitude with the handle 3 protruding in a direction toward a working surface of the workpiece, the angle formed between the driving axis DX and the working surface of the workpiece can be made smaller than that of the conventional power tool. Therefore, the attitude with the handle 3 protruding in a direction toward the surface of the workpiece can be applied to a greater variety of operations.

Thirdly, in the power tool 1A with the battery 28 mounted to the battery mounting part 26, the heavy motor 51 and driving mechanism 6 are arranged in front of the grip part 31 and the heavy battery 28 is arranged behind the grip part 31 in the front-rear direction. With this arrangement, superior operability is realized when the power tool 1A is used in the attitude with the driving axis DX extending in a substantially horizontal direction.

The battery 28 has a rectangular parallelepiped shape, so that, among outer surfaces of the battery 28 mounted to the battery mounting part 26, the mounting surface 280 and the opposite surface 281 are substantially orthogonal to the driving axis DX (see FIG. 5). In this embodiment, the driving axis DX, the rotational axis RX1of the motor 51 and the rotational axis RX2 of the intermediate shaft 60 all pass through the battery mounting part 26 (specifically, the rear wall part 251) and the surface 281 of the battery 28. Thus, the power tool 1A is stably supported when the surface 281 of the battery 28 mounted to the battery mounting part 26 is placed on a substantially horizontal plane (such as an upper surface of a workbench, and the ground).

### Second Embodiment

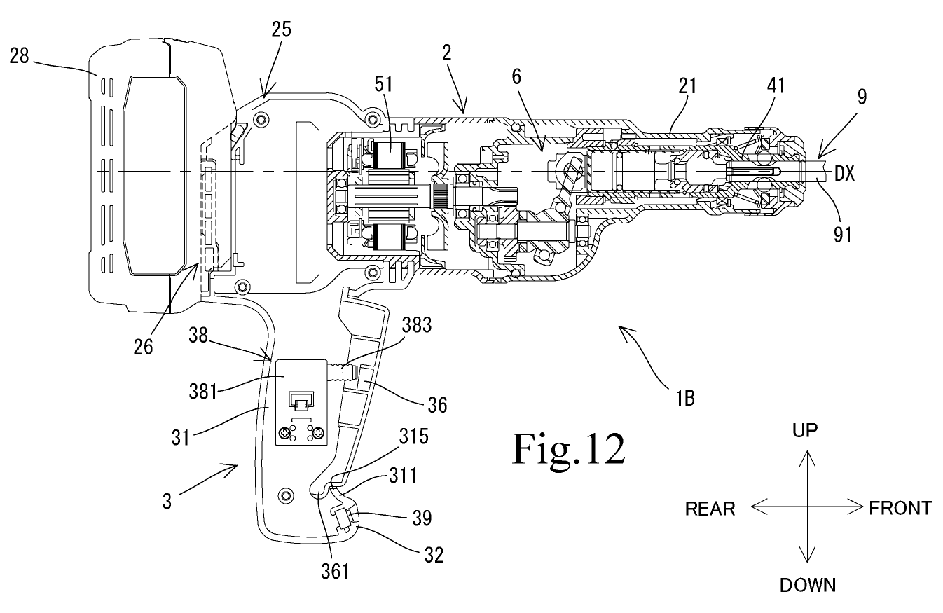

A power tool 1B according to a second embodiment of the present disclosure is now described with reference to FIG. 12. The power tool 1B is different from the power tool 1A (see FIG. 5) of the first embodiment in the manual operation member for starting the motor 51, but otherwise it has substantially the same structure as the power tool 1A. Therefore, in the following description and the drawing referred to therein, components or structures substantially identical to those of the first embodiment are given like reference numerals, and are not described or only simply described.

As shown in FIG. 12, the power tool 1B of this embodiment has the tool body 2 that extends along the driving axis DX and houses the tool holder 41, the motor 51 and the driving mechanism 6. The battery mounting part 26 is provided in the rear end part 25 of the tool body 2. The handle 3 of the power tool 1B is connected to the tool body 2 in a cantilever manner and extends in the up-down direction. A switch lever 36 is arranged on the front side of the grip part 31.

Like the trigger 35 of the first embodiment, the switch lever 36 is a manual operation member that is configured to be depressed by a user to start the motor 51. In this embodiment, the switch lever 36 is arranged in a region including the center position CL of the grip part 31 in the longitudinal direction (substantially in the up-down direction of the power tool 1B). More specifically, the switch lever 36 is arranged to extend over the whole length in the longitudinal direction of the grip part 31 including the center position CL, from the upper end to the lower end of the grip part 31.

The switch lever 36 of this embodiment is supported to be rotatable (swingable) substantially in the front-rear direction (the extending direction of the driving axis DX). More specifically, an opening 315 is formed in the front wall part 311 of the grip part 31 and extends from the upper end to the lower end of the grip part 31. The switch lever 36 is arranged to partially protrude from the front wall part 311 through the opening 315. A lower end part 361 of the switch lever 36 is rotatably engaged with a lower end of the opening 315. Thus, the switch lever 36 can be rotated substantially in the front-rear direction around a position of contact between the lower end part 361 and the opening 315.

The switch 38 is arranged just behind the switch lever 36 within the grip part 31. The protruding end of the plunger 383 of the switch 38 is held in contact with the switch lever 36. In an initial state in which the switch lever 36 is biased forward by the plunger 383 and not subjected to rearward external force, the switch lever 36 is held in a frontmost position. When the switch lever 36 is located in the frontmost position, the switch 38 is in an off state. When the switch lever 36 is depressed and rotated rearward to a prescribed position while pushing in the plunger 383, the switch 38 is tuned on.

As described above, the power tool 1B of this embodiment has the handle 3 that protrudes in a direction crossing the driving axis DX from the tool body 2 extending along the driving axis DX. The switch lever 36 is configured to be depressed to instruct start of the motor 51 and arranged in a region including the center position CL of the grip part 31 in the longitudinal direction. Thus, the switch lever 36 can be easily depressed with one or more fingers of a user, whether the user holds the grip part 31 in the normal orientation or in reverse orientation. In other words, the orientation in which the grip part 31 is held does not substantially affect the operability of the switch lever 36. Thus, like the power tool 1A of the first embodiment, the power tool 1B of this embodiment exhibits superior operability in various attitudes.

Further, the switch lever 36 extends from the lower end to the upper end of the grip part 31, so that the switch 38 can be reliably turned on while the grip part 31 is held whether in the normal orientation or in the reverse orientation. The switch lever 36 is formed long and configured to be rotatable around the lower end part, so that the switch lever 36 can more reliably push in the plunger 383 whether in the normal orientation or in the reverse orientation, compared with a slide type lever.

The battery mounting part 26 of the power tool 1B of this embodiment has the same structure as that of the first embodiment, and therefore has the same effects obtained by the structure of the battery mounting part 26 as those described in the first embodiment.

Correspondences between the features of the above-described embodiments and the features of the present disclosure are as follows. However, the features of the above-described embodiments are merely exemplary and do not limit the features of the present disclosure or invention.

The power tools (having a hammer mechanism) 1A, 1B are examples of the “power tool having a hammer mechanism”. The tool holder 41, the motor 51, the driving mechanism 6, the tool body 2, the handle 3 and the grip part 31 are examples of the “tool holder”, the “driving mechanism”, the “tool body”, the “handle” and the “grip part”, respectively. The trigger 35 and the switch lever 36 are examples of the “operation member”. The battery mounting part 26 is an example of the “battery mounting part”.

The power tool having a hammer mechanism according to the present disclosure is not limited to the power tools 1A, 1B of the above-described embodiments. For example, the following non-limiting modifications may be made. At least one of these modifications can be adopted in combination with at least one of the features of the power tools 1A, 1B of the above-described embodiments and the claimed invention.

The power tool having a hammer mechanism according to the present disclosure may be embodied as a power tool (so-called hammer drill) having a hammer mechanism that is configured not only to apply hammering force to the tool accessory 9 and linearly drive the tool accessory 9 along the driving axis DX, but also to rotate the tool accessory 9. The power tool having a hammer mechanism according to the present disclosure may be of a type in which the handle including the grip part forms a loop together with part of the tool body, instead of a pistol grip type like the above-described embodiments. The power source of the power tool having a hammer mechanism according to the present disclosure may be an external AC power source instead of the battery 28.

The operation member of the power tool having a hammer mechanism according to the present disclosure is not limited to the trigger 35 of the first embodiment and the switch lever 36 of the second embodiment. For example, the trigger 35 may be smaller or larger than that of the first embodiment. The switch lever 36 that can be rotated around the lower end part may just extend from the lower end of the grip part 31 at least to a position beyond the center position CL, and need not necessarily extend to the upper end of the grip part 31. The switch lever 36 may be rotatably supported at the upper end and extend from the upper end of the grip part 31 at least to a position beyond the center position CL.

In view of the nature of the present disclosure and the above-described embodiments, the following aspects are provided. At least one of the aspects can be adopted in combination with at least one of the features of the above-described embodiments and modifications and the claimed invention.

(Aspect 1) The handle is connected to the tool body in a cantilever manner and has a free end.

(Aspect 2) The first direction is a direction substantially orthogonal to the driving axis.

(Aspect 3) The battery mounting part is provided in a rear end part of the tool body, and the handle is arranged between the driving mechanism and the battery mounting part in the front-rear direction.

(Aspect 4) The battery mounting part: (i) is provided in a rear end part of the tool body, and (ii) includes a first connector part that can be electrically connected to a second connector part provided on the battery when the battery is mounted to the battery mounting part via the engagement part; the first connector part is provided on a rear wall part of the tool body that faces a surface of the battery on which the second connector part is provided; and the driving axis crosses the rear wall part.

(Aspect 5) At least part of the motor and the battery mounting part are arranged on the sides opposite to each other relative to the handle in the front-rear direction.

(Aspect 6) The power tool further includes a controller that controls driving of the power tool; the controller is arranged between the motor and the battery mounting part in the front-rear direction; and the driving axis passes through the motor, the controller and the battery mounting part.

(Aspect 7) A line orthogonal to the driving axis passes through the controller and the handle when the power tool is viewed from a second direction orthogonal to the front-rear direction and the first direction.

### Description of the Reference Numerals

1A, 1B: power tool having a hammer mechanism, 2: tool body, 9A: chisel bit, 9B: scoop, 9C: needle scaler, 21: barrel part, 25: rear end part, 251: rear wall part, 253: side wall part, 26: battery mounting part, 261: engagement part, 262: guide groove, 265: connector part, 267: recessed part, 28: battery, 280: mounting surface, 281: surface, 283: guide rail, 285: connector part, 287: locking member, 288: release button, 3: handle, 31: grip part, 311: front wall part, 312: opening, 313: guide, 315: opening, 32: lower end part, 35: trigger, 36: switch lever, 361: lower end part, 38: switch, 381: switch body, 383: plunger, 385: guide, 39: lighting unit, 41: tool holder, 411: small-diameter part, 412: projection, 413: slot, 415: large-diameter part, 421: ball, 423: chuck cover, 50: controller, 51: motor, 515: output shaft, 516: pinion, 6: driving mechanism, 60: intermediate shaft, 601: gear, 61: motion converting mechanism, 611: rotary body, 613: oscillating member, 614: ring part, 615: arm part, 617: piston cylinder, 618: air chamber, 65: striking element, 651: striker, 652: body part, 653: small-diameter part, 655: impact bolt, 656: large-diameter part, 657: small-diameter part, 658: small-diameter part, 7: idle-driving prevention mechanism, 70: O-ring, 71: first sleeve, 72: second sleeve, 9: tool accessory, 90: blade, 91: shank, 92: long groove, 93: recess, 93A: recess, 93C: recess, 900: housing, 901: bottom, 902: opening, 903: needle, 905: holder, 907: anvil, CL: center position, DX: driving axis, RX1: rotational axis, RX2: rotational axis

1. A power tool having a hammer mechanism, comprising:
a tool holder that extends along a driving axis defining a front-rear direction of the power tool, and includes a front end part that is configured to removably hold a tool accessory selected from various kinds of tool accessories;
a motor including an output shaft that is rotatable around a first rotational axis;
a driving mechanism that is operably connected to the output shaft and configured to linearly drive the tool accessory held by the tool holder, along the driving axis when the motor is driven;
a tool body that extends along the driving axis and houses the tool holder, the motor and the driving mechanism;
a handle that is connected to the tool body and includes a grip part extending in a first direction crossing the driving axis; and
an operation member that is provided on a front side of the grip part and configured to be manually operated by a user to instruct start of the motor;
wherein:
the grip part has a first end that is closer to the tool body and a second end that is farther from the tool body, in the first direction; and
the operation member is arranged in a region of the grip part that includes at least a center position of the grip part that is substantially equidistant from the first and second ends in the first direction.

2. The power tool having a hammer mechanism as defined in claim 1, wherein the operation member is arranged apart from the first and second ends of the grip part in the first direction.

3. The power tool having a hammer mechanism as defined in claim 2, wherein the operation member is supported by the grip part so as to be linearly slidable.

4. The power tool having a hammer mechanism as defined in claim 1, wherein the operation member extends from the first or second end of the grip part at least to a position beyond the center position, in the first direction.

5. The power tool having a hammer mechanism as defined in claim 4, wherein the operation member is supported by the grip part to be rotatable around one end part of the operation member in a longitudinal direction.

6. The power tool having a hammer mechanism as defined in claim 1, wherein:
the driving mechanism includes: (i) an intermediate shaft that is operably connected to the output shaft and rotated around a second rotational axis with rotation of the output shaft; and (ii) an oscillating member that is arranged on the intermediate shaft and oscillated in the front-rear direction with rotation of the intermediate shaft; and (iii) a piston that is operably connected to the oscillating member and linearly reciprocated along the driving axis with oscillation of the oscillating member;
the driving axis, the first rotational axis and the second rotational axis are parallel to each other; and
the handle protrudes from the tool body in a direction toward the second rotational axis.

7. The power tool having a hammer mechanism as defined in claim 6, wherein the first rotational axis of the output shaft is arranged between the driving axis and the second rotational axis of the intermediate shaft in the first direction.

8. The power tool having a hammer mechanism as defined in claim 1, further comprising:
a battery mounting part to which a battery is removably mounted,
wherein:
the driving axis passes through the battery mounting part when the power tool is viewed from a second direction orthogonal to the front-rear direction and the first direction.

9. The power tool having a hammer mechanism as defined in claim 8, wherein the battery mounting part includes an engagement part that is configured to be slidingly engaged with the battery in a direction crossing the driving axis.

10. The power tool having a hammer mechanism as defined in claim 9, wherein the engagement part is configured to be slidingly engaged with the battery in the first direction.

11. The power tool having a hammer mechanism as defined in claim 10, wherein:
the battery mounting part is arranged behind the grip part in the front-rear direction; and
the battery mounting part is configured such that the battery mounted to the battery mounting part is located on a side opposite to the second end of the grip part in the first direction relative to a region behind the grip part where the user places a hand when holding the grip part.

12. The power tool having a hammer mechanism as defined in claim 8, wherein:
the battery mounting part is provided in a rear end part of the tool body; and
the handle is arranged between the driving mechanism and the battery mounting part in the front-rear direction.

13. The power tool having a hammer mechanism as defined in claim 9, wherein:
the battery mounting part: (i) is provided in a rear end part of the tool body, and (ii) includes a first connector part that is configured to be electrically connected to a second connector part provided on the battery when the battery is mounted to the battery mounting part via the engagement part;
the first connector part is provided on a rear wall part of the tool body that faces a surface of the battery on which the second connector part is provided; and
the driving axis crosses the rear wall part.

14. The power tool having a hammer mechanism as defined in claim 8, further comprising:
a controller that controls driving of the power tool;
wherein:
the controller is arranged between the motor and the battery mounting part in the front-rear direction; and
the driving axis passes through the motor, the controller and the battery mounting part.

15. The power tool having a hammer mechanism as defined in claim 1, wherein the tool holder is configured to receive a shank protruding from a rear end of the tool accessory and hold the shank so as to be slidable along the driving axis.

16. The power tool having a hammer mechanism as defined in claim 1, wherein the handle is connected to the tool body in a cantilever manner and has a free end.
